(19) United States
(12) Patent Application Publication
(10) Pub. No.: US 2008/0111877 A1
(43) Pub. Date: May 15, 2008

(54) Thermal Laser Printing

(75) Inventors: Geert Heyse, Sint-Kathelijine-Waver (BE); Kris Vandermeulen, Bornem (BE); Jos Vleurinck, Oordegem (BE); Geert V. Aerde, Lokeren (BE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: DYMO, Sint-Niklaas (BE)

(21) Appl. No.: 11/629,232

(22) PCT Filed: Jun. 10, 2005
(86) PCT No.: PCT/IB05/02265

§ 371 Date: Dec. 11, 2007

(30) Foreign Application Priority Data
Jun. 10, 2004 (GB) 0412969.8

(51) Int. Cl. G01D 15/10; G09F 3/00; B41M 5/34; B41J 3/407

(52) U.S. Cl. 347/220; 40/625

(57) ABSTRACT

A direct thermal printing material having at least one planar layer containing thermally activatable materials, wherein said planar layer forms an image upon application of laser light.

### FIELD OF THE INVENTION

The present invention relates to thermal printing, in particular, direct thermal printing wherein a laser is used as a heat source.

### BACKGROUND TO THE INVENTION

Conventional thermal printers use a platen and thermal printhead to apply heat to an image-receiving material in order to generate an image thereon.

Direct thermal printing requires the use of a printing material comprising a substrate adapted to undergo a change in optical properties upon the application of a heat source, the heat source being a thermal print head. The pattern of heat applied to the substrate is controlled so as to determine a pattern formed on the substrate, so that image may thereby be created.

Thermal transfer printing requires the use of a plurality of printing materials comprising at least an image-receiving substrate and an ink ribbon or such like. The image-receiving substrate and the ink ribbon are held together in cooperation between a platen and a print head. Upon application of heat by a thermal print head, ink is transferred from the ink ribbon to the image-receiving layer. By controlling the pattern of heat applied to the ribbon and substrate, the pattern of ink transferred to the substrate may be controlled, and thus an image may be created.

Both direct thermal printing and thermal transfer printing require the precise control of a plurality of printing elements of the thermal print head in order to generate a pattern or image upon the substrate.

A printing apparatus using conventional thermal printing methods is limited to an operation on flat materials.

### TOPPAN—Vacuum Metalized Layer

A metallic colour direct thermal film material 80 that is known in the art is shown in FIG. 1. This material comprises PET substrate layer 81, an image receiving material 82, and a protection layer 83. The image receiving material 82 comprises 3 layers: a coloured image layer 84, a vacuum metalized layer 85 that is heat sensitive, and a coloured surface layer 86.

### Agfa-Gevaert—Microcapsules

European Patent application EP0736799 (Fuji) describes a colour forming layer comprising: (a) a heat-responsive microcapsule having encapsulated therein an organic silver salt; (b) a reducing agent or a developer for the organic silver salt; and (c) a water-soluble binder.

European Patent Application EP1135258 (Agfa Gevaert) discloses a label material produced using a monosheet construction. These are substantially transparent imaging materials based on organic silver salts that do not fade and have excellent light stability and image tone. The image density is primarily dependent upon the heating energy used to produce a dot.

Thermal printing is usually limited to monochrome because colour thermal printing usually requires more than one printhead and multiple ink ribbons. Such an apparatus is generally bulky and complex.

International patent application WO 02/096665 (Polaroid) discloses a multicolour imaging system wherein at least two, and preferably three, different image-forming layers of a thermal imaging material are addressed at least partially independently by a thermal print head by controlling the temperature of the thermal print head and the time thermal energy is applied to the image-forming layers. Each colour of the thermal imaging material can be printed alone or in a selectable portion with the other colours. A temperature-time domain is divided into regions corresponding to the different colours required to combine in a final print. FIG. 2 is a graphical representation illustrating the temperature and time parameter features of such a direct thermal media for printing magenta, cyan and yellow. The temperature selected for the colour-forming regions generally are in the range of from approximately 50° C. to approximately 450° C. The time period for which the thermal energy is applied to the colour-forming layers of the imaging member may be in the range of approximately 0.01 to about 100 milliseconds.

Referring now to FIG. 3, there is seen a pre-colour thermal imaging member that utilises thermal delays to define the printing regions for the colours to be formed. The three colour imaging member 30 includes substrate 31, cyan, magenta and yellow image-forming layers, 32, 33, 34, respectively, and spacer interlayers 35, 36.

Where the image member is heated by a thermal print head from above, the cyan image-forming layer 32 will be heated almost immediately by the thermal print head after the heat is applied, but there will be a significant delay before the magenta image-forming layer 33 and the yellow image-forming layer 34 are heated according to the thermal conductivity and thickness of the spacer layers 35, 36. To provide multicoloured printing it is preferable that each image-forming layer is arranged to be activated at a different temperature. This result can be achieved, for example, by arranging the image-forming layers to have different melting temperatures or by incorporating in them different thermal solvents, which will melt at different temperatures and liquefy the image-forming materials. For example, if the activation temperature for the cyan layer is T1, the activation temperature for the magenta layer is T2 and the activation temperature for the yellow image-forming layer is T3, then the activation temperatures may be selected such that T1>T2>T3. Accordingly, application of a temperature between T2 and T3 for a relatively long time period will produce a yellow colour without any cyan or magenta colour. A relatively short, high temperature heat pulse above T1 will produce a cyan colour without any magenta or yellow colour. Application of a temperature between T1 and T2 for a suitable length of time will produce a magenta colour. Accordingly, by varying the temperature and time of heating, individual colours or mixtures thereof may be produced so as to generate a multicolour image.

International patent application WO 03/102952 (Hewlett-Packard) describes using a read-laser from a CD reader/writer to record an image on a label face of a CD in monochrome.

European patent application EP 1,308,938 (Yamaha) describes the use of a write-laser for recording an image in a thermo-sensitive layer, wherein either the laser irradiation period or the laser power, or both, is controlled so as to change the density of a visual image formed on the thermo-sensitive face of an optical disc.

United States patent application US 2003/0,179,679 (Yamaha) describes a method and apparatus for creating a full colour image on the label side of a CD. The examples disclosed by this application result in component colours being created in close proximity so as to produce the effect of different colours. The first example describes a simple multi-layer substrate that requires three passes of a laser over the label surface and a UV fixing step between each pass in order to generate a coloured image. This example disadvantageously requires a complex printing apparatus comprising two UV lamps of different frequencies. The second and third examples described by this document require a complex label layer in order to allow an image to be created.

### Conventional Printing on Optical Discs [www.exemplar-uk.com, www.rimage.com]

Conventional commercial methods for printing on optical discs include: silk-screen printing; full colour ink-jet printing; and thermal transfer printing. Silk-screen printing produces offset printing with either CMYK or Pantone™ spot colours. Silk-screen printing is generally cost effective for production runs of 500 optical discs or more. Full colour ink-jet printing produces images up to 2400 dots per inch, and is suitable for production runs of less than 500 optical discs. Thermal transfer printing is suitable for simple monochrome text or graphics and is appropriate for one off optical discs and small production runs.

However, while more consumers are recording their own data onto optical media, none of the above methods for printing on an optical disc are readily available to the consumer at home.

It is an aim of the embodiments of the present invention to address at least one of the above-described problems.

### SUMMARY OF THE INVENTION

According to a first aspect in the present invention, there is provided a direct thermal printing material having at least one planar layer, said planar layer containing thermally activated materials, wherein said planar layer forms an image upon application of laser light.

Preferably, said planar layer contains at least one thermally activated material.

Preferably each of said at least one thermally activated materials produces a distinct colour upon application of laser light.

Preferably, said direct thermal printing material has a plurality of planar layers, each of said planar layers containing at least one thermally activated material, and each of said planar layers producing a distinct colour upon application of laser light.

Preferably each of said plurality of planar layers have different thermal responsiveness.

Preferably, at least three planar layers are provided wherein each of said planar layers is arranged to form a different colour such that a full colour image is generatable.

Preferably, at least one planar layer has light and/or heat absorbing properties.

Preferably, the direct thermal printing material comprises at least one light absorbing layer.

Preferably, the light absorbing layer is adapted to absorb light at a frequency of laser light incident there on.

Preferably said light absorbing layer is substantially transparent to light in the visible spectrum.

Preferably said light absorbing layer comprises a layer detachable from the direct thermal printing material.

Preferably, said light absorbing layer is an uppermost layer.

Preferably at least one light absorbing layer is provided between a first and second planar layer.

At least one buffer layer may be provided, provided between a first and a second planar layer.

Preferably, said buffer layer is arranged to reduce heat conduction between first and a second planar layer.

According to a second aspect in the present invention, there is provided a direct thermal printing apparatus for an optical disc, said optical disc comprising a label, said label comprising a direct thermal printing material as claimed in any preceding claim, wherein said thermal printing apparatus comprises a hub for rotatably mounting said optical disc, a print head spanning a radius of said optical disc, a plurality of rollers arranged to bias the label of the optical disc against the print head, wherein at least one of said rollers is a driven roller arranged to rotate the optical disc about the hub.

According to a third aspect in the present invention, there is provided an optical disc drive comprising a direct thermal printing apparatus for an optical disc, said optical disc comprising a data face and a label face, said data face being parallel to said label face, wherein said label face comprises a direct thermal printing material as claimed in any preceding claim, and wherein said optical disc drive comprises, a driven hub for rotatably mounting said optical disc, a data apparatus arranged to at least read data from a data face of said optical disc, at least one print laser arranged to print an image to a label face of said optical disc, wherein said print laser is mounted on a laser support, wherein said laser support is arranged to move between an inner circumference and an outer circumference on the label face.

According to a fourth aspect in the present invention, there is provided a printing apparatus for printing labels for a disc, said printing apparatus comprising at least one laser for printing an image on a direct thermal printing material be applied to a disc, said direct thermal printing material comprising at least one planar layer containing thermally activated materials, said at least one laser being arranged to activate said thermally activated materials to define an image.

According to a fifth aspect in the present invention, there is provided a label printing apparatus comprising at least one print laser arranged to apply laser light to a label material so as to generate an image.

### BRIEF DESCRIPTION OF THE DRAWINGS

For a better understanding of the present invention and as to how the same may be carried into effect, reference will now be made by way of example to the accompanying drawings in which:

FIG. 1 shows a known printing material;

FIG. 2 shows a graph of time versus temperature for a known material;

FIG. 3 shows a known material;

FIG. 4 shows a first material embodying the present invention;

FIG. 5 shows a second material embodying the present invention;

FIG. 6 shows a third material embodying the present invention;

FIG. 7 shows a fourth material embodying the present invention;

FIG. 8 shows a fifth material embodying the present invention;

FIG. 9 shows a first label printer embodying the present invention;

FIG. 10 shows a second label printer embodying the present invention;

FIG. 11 shows a sixth material embodying the present invention;

FIG. 12 shows a seventh material embodying the present invention;

FIG. 13 shows a label material embodying the present invention;

FIG. 14 shows a third label printer embodying the present invention;

FIG. 15 shows a cross section of a CD;

FIG. 16 shows a plan view of an optical disc printer embodying the present invention; and

FIG. 17 shows a cross sectional view of the optical disc printer shown in FIG. 16.

FIG. 18 shows the structure of a conventional pre-recorded optical disc;

FIG. 19 shows a first view of one embodiment of the present invention comprising apparatus for performing direct thermal printing;

FIG. 20 shows the apparatus of FIG. 19 from a different view;

FIG. 21 shows a laser beamed onto a routing mirror service;

FIG. 22 shows the laser beamed onto a curved image receiving medium;

FIG. 23 shows a mirror moving across the width of a label medium;

FIGS. 24 and 25 show error correction due to movement on the medium in embodiments of the present invention;

FIG. 26 shows an optical setup used in an embodiment of the invention;

FIG. 27 shows a second optical setup used in embodiments of the invention;

FIG. 28 shows a material with which embodiments of the present invention can be used;

FIG. 29 shows a swelling tape with which embodiments of the present invention can be used;

FIG. 30 uses a material with a carbon ribbon which can be used in embodiments of the present invention;

FIG. 31 illustrates how the material of FIG. 30 can be used;

FIG. 32 illustrates a further material which can be used in embodiments of the present invention;

FIG. 33 shows a graph of absorbance versus wavelength for four colours in preferred embodiments of the present invention;

FIG. 34 shows in FIGS. 34a to k various raster colour options;

FIG. 35 shows a diode and lens arrangement in an embodiment of the present invention;

FIG. 36 shows an embodiment using an array of laser light emitters; and

FIG. 37 shows possible arrangements of the emitters of FIG. 36.

### DETAILED DESCRIPTION OF PREFERRED EMBODIMENTS OF THE PRESENT INVENTION

### Three Colour Material—Light Absorbing Layer

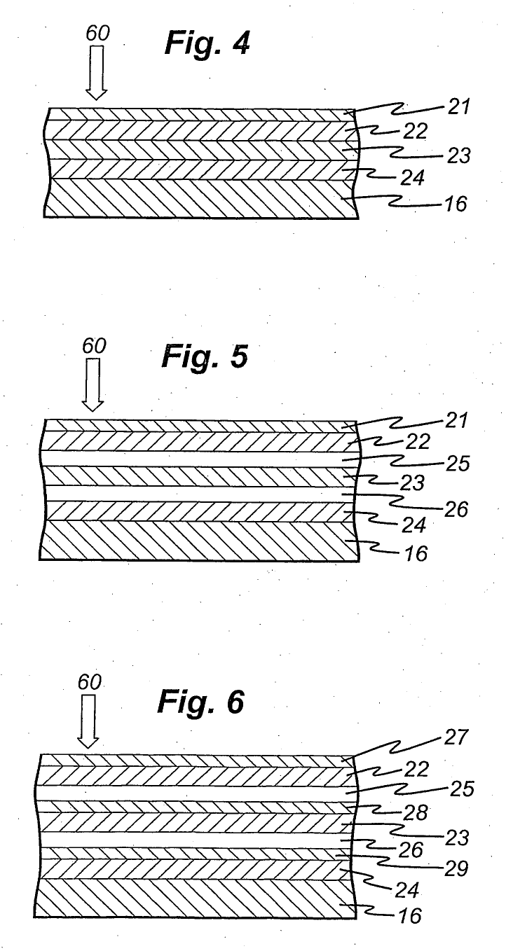

FIG. 4 shows a first embodiment of an image-receiving material according to the present invention. The image-receiving material comprises substrate 16, a first colour-forming layer 24, a second colour-forming layer 23, a third colour-forming layer 22, and a light-absorbing layer 21. The first, second and third colour forming layers respond upon heating to create a first, second and third colour respectively. The first, second and third colour may correspond to red, green and blue respectively. Alternatively, the first, second and third colour may correspond to cyan, magenta and yellow respectively.

The first, second and third colour forming layers may have different thermal responsivity. For example, the first colour forming layer may react to generate colour in response to a relatively low temperature heat source applied over a relatively long period of time; the third colour forming layer may react to generate colour in response to a relatively high temperature heat source applied over a relatively short period of time; and the second colour forming layer may react to generate colour in response to a relatively intermediate temperature heat source applied over a relatively intermediate period of time.

A pattern of laser light of variable intensity is applied to the light-absorbing layer 21 from a source external to the image-receiving material. The light-absorbing layer is chosen so as to be highly absorbing at the frequency of light emitted by the laser source. The temperature increase generated in the light-absorbing layer 21 is directly proportional to the intensity of laser light incident thereon. The temperature and irradiation for which this temperature is generated in the light-absorbing layer 21 determines which of the colour-forming layers 22, 23, 24 reacts so as to generate a colour.

Preferably, the light-absorbing layer 21 has a very high absorption for the selected frequency of laser light and is also a poor conductor such that a large lateral thermal gradient can be created in order to improve printing resolution. The light-absorbing layer 21 is preferably highly absorbing to light at the frequency of the laser light used to develop a material in the image-receiving material, but also highly transmissive for light in the visible spectrum such that a person can see colour formed in any one of the colour-forming layers 22, 23, 24.

Alternatively, the light absorbing layer 21 is highly absorbing to light of all frequencies such that a laser of any frequency can be used to generate an image in the image-receiving material. In order for a person to view the image formed in the image-receiving material, the light-absorbing layer 21 is removed. In order to facilitate this, the light-absorbing layer 21 preferably only weakly bonds to an upper most layer 22 during manufacture and may for example be connected to the layer 22 by means of a suitable layer of adhesive.

### Buffer Layers

FIG. 5 shows an alternative embodiment of the present invention in which the three colour-forming layers 22, 23, 24 are separated by buffer layers 25, 26. The thermal properties of the buffer layers 25, 26 are chosen so as to increase colour separation between the colour-forming layers. For example, first thermal buffer layer 25 acts so as to reduce the heat applied to the second colour forming layer when a relatively high temperature heat source is applied to the printing material for a relatively short period of time so as to cause colour to be formed in the first colour forming layer. Reducing the heat applied to the second colour forming layer in this instance is preferable as it allows for increased tolerance to varying temperatures due to, for example, a broad range of ambient temperatures in which the printing material is to be used.

### One Frequency of Laser Light

In one embodiment, the laser light incident upon the light-absorbing layer 21 is of a single frequency.

### Multiple Frequency Laser Light

In an alternative embodiment shown in FIG. 6, the image-receiving material comprises a substrate 16, a first light-absorbing layer 27, a first colour-forming layer 22, a first buffer layer 25, a second light-absorbing layer 28, a second colour-forming layer 23, a second thermal buffer layer 26, a third light-absorbing layer 29, and a third colour-forming layer 24. The first, second and third colour-forming layers 22, 23, 24 are for example red, green and blue. Each of the three light-absorbing layers 27, 28, 29 is highly absorbing to light of a respective different frequency. A laser light source capable of generating laser light at three different frequencies may comprise either three independent laser dyes adapted to generate light of a different frequency or a single laser dye adapted to generate laser lights at any one of three particular frequencies.

The first light absorbing layer 27 is highly absorbing to light of a first frequency and highly transmissive of light at a second and third frequency. The second light-absorbing layer 28 is highly absorbing to light at a second frequency but highly transmissive of light at a first and third frequency. The third light-absorbing layer 29 is highly absorbing to light at a third frequency but highly transmissive to light at the first and second frequencies. Accordingly, when light of a first frequency is incident upon the image-receiving material heat is generated in the first light absorbing layer 27 causing colour to be developed in the first colour-forming layer 22. Laser light of a second frequency incident upon the image-forming material causes heat to be generated in the second light-absorbing layer 28 and correspondingly, causes colour to be developed in the second colour-forming layer 23.

First thermal buffer 25 is provided to prevent colour formation in the first colour-forming layer 22 when heat is generated in the second light-absorbing layer 28. Laser light of a third frequency incident upon the image-forming material causes heat to be generated in the third light-absorbing layer 29 and correspondingly, causes colour to be developed in the third colour-forming layer 24. Second thermal buffer 26 is provided to prevent colour formation in the second colour-forming layer 23 when heat is generated in the third light-absorbing layer 29.

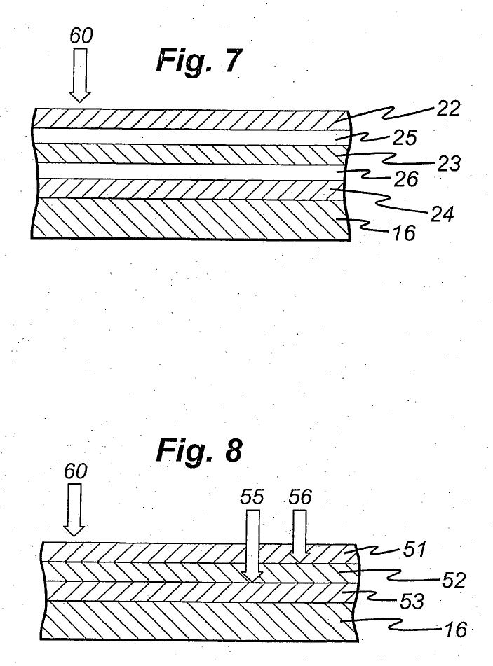

Alternatively, as shown in FIG. 7, the first, second and third colour-forming layers are adapted to be highly absorbing to light at a first, second and third frequency respectively. In this embodiment the colour forming layer performs the role of light absorption and so separate light absorbing layers are not required. These colour-forming layers may be adapted to fulfil this function by mixing a colour-forming material with a material having the appropriate absorption/transmission properties. Each colour-forming layer is highly absorbing to light of a particular frequency and transmissive to the two other frequencies used to generate an image in the image-receiving material.

Preferably, the formation of colour in one of the colour-forming layers does not affect its absorption/transmission properties at any one of the three frequencies used for image development.

Alternatively, where a combination of colour-forming materials and laser light frequencies is chosen such that once colour is formed in one of the colour-forming layers it becomes more absorbing to light of any one of the three frequencies, then preferably, an image is developed on the image-receiving material in at least three steps. In a first step, laser light of a third frequency is used to develop colour in the third colour-forming layer. In a second step, laser light of a second frequency is used to develop colour in the second colour-forming layer. In a third step, laser at a first frequency is used to develop colour in the first colour-forming layer.

In an alternative embodiment of the present invention, the three colour-forming layers are spatially separated in space so as to provide colour separation in the image-receiving material. The first, second and third colour-forming layers 22, 23, 24 respectively are each moderately absorbing to light of a single frequency. Laser light is applied to the image-receiving material from a source capable of focussing at each of the three different depths coinciding with each of the three colour-forming layers. Such a laser system may comprise a single laser with an adaptive focussing system or, alternatively, a plurality of lasers focussed at each of the different depths of the colour forming layers. The distance between the layers and a difference in power intensity of the laser light over that distance are selected such that colour-forming only takes place in a selected image-forming layer.

Alternatively, a plurality of laser light sources are focussed at a single point within the image-receiving material so as to achieve a larger drop in power intensity per unit distance.

The first and second thermal buffer layers 25, 26 respectively, are preferably highly transmissive for visible light and the frequency of light of the laser source. Preferably, the first and second thermal buffer layers 25, 26 respectively act as thermal insulators.

### Ultra Violet Light Fixing

In an alternative embodiment, a colour forming compound in each of the colour forming layers is thermal activated at a predetermined temperature. Upon thermal activation, the colour forming layer forms a colour, the colour is preferably visible to a user. The colour forming layer may be fixed by the application of Ultra Violet light of a particular frequency to the colour forming layer. Once fixed, further colour formation in the colour forming layer is inhibited.

Each colour forming layer may have a thickness of about 30 μm. Distributed within each colour forming layer are a large number of capsules each having a diameter of about 1 μm. The capsules contain colour formers, which may comprise diazonium salt compounds. Upon the application of heat to one of the respective colour forming layers, the capsules disintegrate releasing the colour formers previously contained therein. The released colour formers react with colour developers dispersed in the colour forming layers around the capsules so as to generate a colour. Each colour forming layer is arranged to have a different energy band for its sensitivity to heat.

An example of such a material is shown in FIG. 8, which shows a colour forming material comprising three colour forming layers 51, 52 and 53. Specifically, a first colour forming layer 51 may contain blue colour former, and be reactive at a relatively high temperature to form a blue colour. A second colour forming layer 52 may contain a green colour former and be reactive at a relatively intermediate temperature to form a green colour. A third colour forming layer 53 may contain a red colour former and be reactive at a relatively low temperature to form a red colour.

The colour formers contained within the colour forming layers are designed to decompose upon illumination with different wavelengths of ultraviolet radiation. After colour is formed in the third colour forming layer 53, any remaining unreacted colour former within the third colour forming layer is caused to decompose upon the application of UV light of a first frequency 55. This causes the third colour forming layer to be unresponsive (i.e. no further colour is formed) when heat is applied to the colour forming material to develop colour in the second and first colour forming layers. Further, after the second colour forming layer 52, any remaining unreacted colour former within the second colour forming layer is caused to decompose upon the application of UV light of a second frequency 56. This causes no further colour to develop in the second colour forming layer when heat is applied to the colour forming material to develop colour in the first colour forming layer.

The Ultra Violet light required to fix the colour forming layers may be provided by two dedicated UV lamps, a first lamp for generating UV light of the first frequency and a second lamp for generating light of the second frequency.

A printing apparatus 100 suitable for generating an image in an image-receiving material comprising the colour forming material 51, 52 and 53 of a label substrate 11 is shown in FIG. 9. The dashed line shows the path of the label substrate. The label substrate may be supplied from a reel, said reel housed in a tape cassette. The apparatus comprises a platen roller 101 that may be driven so as to drive the label substrate past a thermal print head 102. Preferably, the print head 102 is movable between a first position wherein the print head separated from the platen, and a second position wherein the print head is held by a biasing means against the platen. In the second position, the platen roller 101 cooperates with the print head 102 so as to provide a means for driving a label substrate through the apparatus. The printing apparatus 100 further comprises first and second UV lamps 103 and 104 respectively, each for fixing an image formed in one of the colour forming layers 52 and 53.

The operation of printing apparatus 100 will now be described. Upon insertion of an appropriate label substrate, print head 102 is moved into cooperation with platen 101. Platen 101 is driven in a forward direction so as to drive a label substrate past the print head 102. Print head 102 may comprise a plurality of heat sources arranged along the surface of the label substrate in a line perpendicular to the direction of movement of the tape. The heat sources are activated by a control circuit for a period of time determined by the temperature required in the third image forming layer so as to generate a particular image. After a first printing pass, the platen is driven in a reverse direction, and the first UV lamp 103 is turned on. The image in the third colour forming layer is fixed by the first UV lamp as the label substrate is rewound. Alternatively, the image in the third colour forming layer is fixed by the UV lamp immediately after the first printing pass during the forward direction and the platen is driven in a reverse direction after the fixing step to bring the image forming material back in its original position. A second printing pass may then be performed to create an image in the second colour forming layer. After the second printing pass, the platen is driven in a reverse direction, and the second UV lamp 104 is turned on. The image in the second colour forming layer is fixed by the second UV lamp as the label substrate is rewound a second time. Alternatively, the image in the second colour forming layer is fixed by the UV lamp 104 immediately after the second printing pass during the forward direction and the platen is driven in a reverse direction after the second fixing step to bring the image forming material back in its original position. In a third and final printing pass, an image is created in the first colour forming layer. Preferably, after the first and second printing pass, the label substrate is rewound accurately so that a next printing pass begins in the same position as the printing pass before it. In this manner precise colour registration in the final image can be achieved.

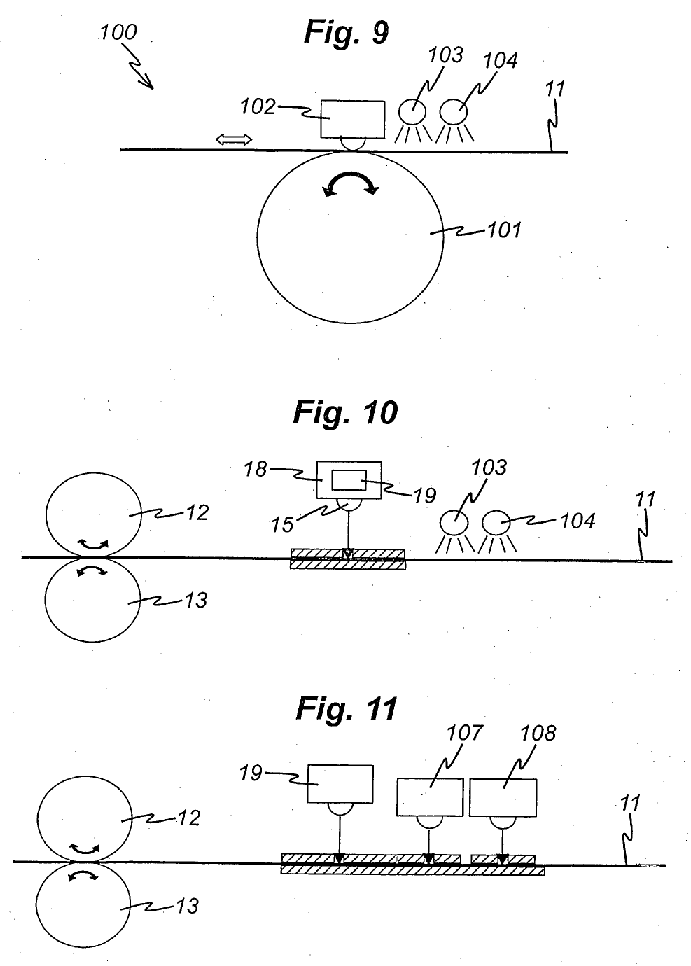

In another alternative embodiment, a printing apparatus suitable for generating an image in an image-receiving material, a label substrate 11 is shown in FIG. 10. The label substrate 11 may be supplied from a reel, said reel housed in a tape cassette. The apparatus comprises two rollers 12, 13, one or both of which may be driven so as to drive the label substrate 11 past a laser source 19. A lens 15 is provided to focus light from the laser source 19 onto the label substrate 11. The lens 15 may be movable within a laser housing 18 in order to allow laser light to be focussed at different depths within the label substrate 11. The laser source 19 and lens 15 are mounted in a laser housing 18. The laser housing 18 may be movable across the width of the label substrate 11, in a direction into and out of the page of FIG. 10. An apparatus suitable for moving the laser housing 18 across the width of the label substrate 11 may be similar to the transverse laser tracking system of an optical disc drive. The printing apparatus shown in FIG. 10 further comprises UV lamps 103 and 104 in order to fix an image in at least one of the image forming layers as described above.

In an alternative embodiment, first and second UV lamps 103 and 104 are replaced with first and second UV lasers 107 and 108 that emit laser light at the first and second frequencies respectively as shown in FIG. 11. The UV lasers may be arranged on a driven mount so as to scan across the width of the label material when activated. Alternatively, the first and second UV lasers may be arranged to cooperate with at least one diffractive element such that UV laser light is incident across a whole width of a label material when the laser is in a fixed position.

In another alternative, the first and second lasers can be replaced by UV generating Light Emitting Diodes (LED).

The label printing apparatus described herein may be a hand held device or a desktop device.

### Monochrome Printing

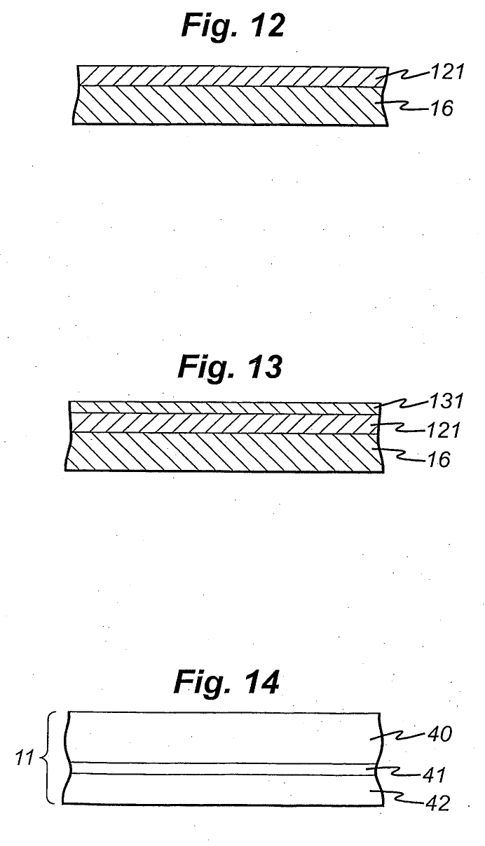

Monochrome printing may be achieved using an image-receiving material as shown in FIG. 12. The colour of the image can be black, red, yellow, blue, orange or any other colour depending on the chemical composition of the material. The image-receiving material shown in FIG. 11 comprises a single colour-forming layer 121. Preferably, the wavelength of laser light chosen to generate an image in the image-receiving material is such that the colour-forming layer 121 is highly absorbing to that frequency. Alternatively, the colour-forming layer 121 comprises a mixture of a colour-forming material and a light-absorption material and it has a very high absorption for the selected laser wavelength such that light incident of this wavelength is converted to heat within the colour-forming layer 121.

### Agfa-Gevaert

The label substrate 11 may comprise a support layer having provided thereon at least a colour forming layer 121. The colour forming layer 121 may comprise: (a) a heat-responsive microcapsule having encapsulated therein an organic silver salt; (b) a reducing agent or a developer for the organic silver salt; and (c) a water-soluble binder.

Organic silver salts for use as a component of the colour forming layer include a light-fast colourless or white silver salt such as silver behenate which is heated to a temperature greater than 100° C. with a reducing agent. The silver salt undergoes a redox reaction that produces a silver image. The organic silver salt is encapsulated, such that a high concentration of the organic silver salt can be contained in the microcapsule. The organic silver salt incorporated in the microcapsule is isolated from the reducing agent at room temperature. However, the microcapsule wall becomes permeable to the reducing agent arranged outside the microcapsules at higher temperatures such that the organic silver salt reacts with the reducing agent. Thus, the reduction reaction is inhibited at room temperature. The combined use of microcapsules and a water-soluble binder provides a recording layer coating solution in an aqueous form.

The microcapsule can be prepared by any of interfacial polymerization, internal polymerization and external polymerization. Interfacial polymerization comprises emulsifying a core substance comprising an organic silver salt that has been dissolved or dispersed in an organic solvent in an aqueous solution having a water-soluble polymer therein and then forming a polymer wall around the emulsified oil droplets of the core substance.

The organic silver salt is a light-fast colourless or white silver salt which, regardless of whether an exposed silver halide is present or not, undergoes a redox reaction to produce silver when heated with a reducing agent. The organic silver salt is a silver salt of an organic compound having an imino group, a mercapto group or a carboxyl group. Examples of the organic silver salt are given below.

### 1) Silver salt of an organic compound having an imino group; such as Saccharin silver, phthalazinone silver, or benzotriazole silver.

### 2) Silver salt of an organic compound having a mercapto group or a thione group; such as Silver salt of 3-(2-carboxyethyl)-4-oxymethyl-4-thiazoline-2-thione, or silver salt of 3-mercapto-4-phenyl-1,2,4-triazole.

### 3) Silver salt of an organic compound having a carboxyl group; such as Silver stearate or silver behenate.

Most preferred among these organic silver salts is silver behenate, which is white and fast to light and exhibits excellent moisture resistance. Furthermore, silver behenate can be combined with a mild reducing agent, and can be used with known excellent colour toners. The silver salt is preferably a desalted and purified organic silver salt. A desalted and purified organic silver salt is advantageously used when a high concentration of the organic silver salt is required in order to create a high density image.

The developer is a reducing agent. When heated, the reducing agent reduces the organic silver salt to produce silver. The reducing agent must be able to undergo a rapid reduction reaction at the desired development temperature. Furthermore, it must not adversely affect the colour tone of the developed image.

Examples of useful reducing agents include hydroxycoumarones, hydroxycoumarans, sulfoamidephenols, sulfoamidenaphthols, hydradones, hydroxaminic acids, bis-beta-naphthols, indane-1,3-diones, aminophenols, aminonaphthols, pyrazolidine-5-ones, hydroxylamines, reductones, hydrazines, hydroquinones, polyphenols such as bisphenol A, bisphenol B and gallates, phenylenediamines, hydroxyindanes, 1,4-dihydroxypyridines, amidoxims, hydroxy-substituted aliphatic carboxylic acid arylhydrazides, N-hydroxyureas, phosphonamidephenols, phosphonamidanilines, alpha-cyanophenylacetic esters and sulfonamideanilines.

The water-soluble binder for use in the recording layer is a compound which not only binds the developer and microcapsule contained in the recording layer, but also bonds the recording layer to the support. Examples of the water-soluble binder include water-soluble polymers such as gelatin, gelatin derivatives (e.g., phthalated gelatin), polyvinyl alcohol, methyl cellulose, carboxymethyl cellulose and hydroxypropyl cellulose, and various emulsions such as gum arabic, polyvinyl pyrrolidone, casein, styrene-butadiene latex, acrylonitrile-butadiene latex, polyvinyl acetate polyacrylic ester and ethylene-vinyl acetate copolymer.

### TOPPAN—Vacuum Metalized Layer

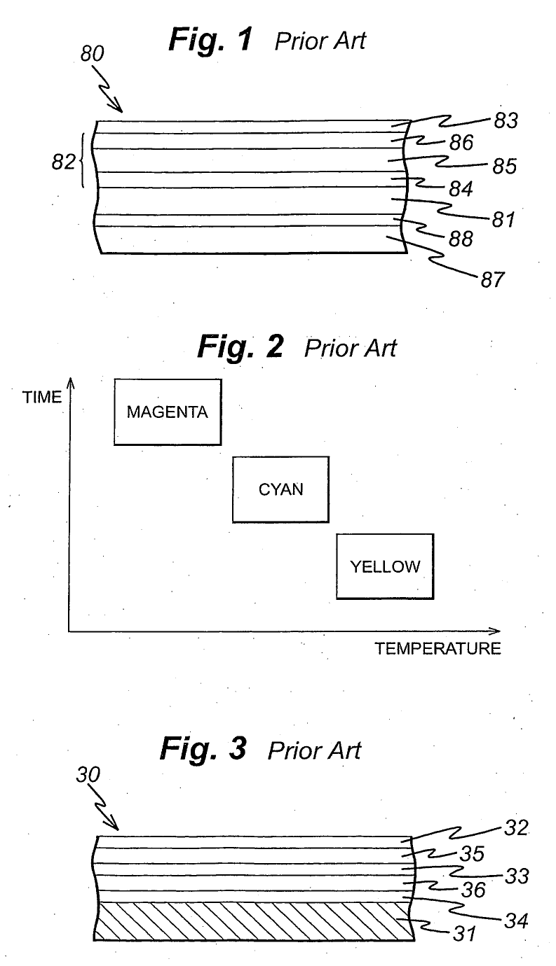

Alternatively, the colour forming layer 121 may comprise a metallic colour direct thermal film material, such as that shown in FIG. 1. This material comprises a PET substrate layer 81, an image receiving material 82, and a protection layer 83. The image receiving material 82 comprises 3 layers: a coloured image layer 84, a vacuum metalized layer 85 that is heat sensitive, and a coloured surface layer 86 that is transparent or translucent. The image is formed in the underlying layer 84. Energy from an external heat source applied to an area of the material shrinks a corresponding area of the vacuum metalized layer, causing a portion of the coloured image layer 84 to become visible. The protection layer 83 may be a protective overlaminate, which remains intact after heating so as to protect the image receiving layer from harsh environments.

The metallic colour direct thermal film material 80 may also comprise a backing material 87 weakly adhered to the substrate layer 81 by an adhesive layer 88. Preferably, the backing material 87 is removable so as to reveal the adhesive layer 88 so that the material 80 may be adhered to a surface.

### Light Absorbing Layer

An alternative embodiment of the present invention is shown in FIG. 12, in which the colour-forming layer 121 is covered by a light-absorbing layer 131. Preferably, the light-absorbing layer 132 has a very high absorption for the selected frequency of laser light and is also a poor conductor such that large lateral thermal gradient can be created in order to improve printing resolution. The light-absorbing layer 132 is preferably highly absorbing to light at the frequency of the laser light used to develop a material in the image-receiving material, but also highly transmissive for light in the visible spectrum such that a person can see colour formed in the colour-forming layer 121.

Alternatively, the light absorbing layer 132 is highly absorbing to light of all frequencies such that a laser of any frequency can be used to generate an image in the image-receiving material. In order for a person to view the image formed in the image-receiving material, the light-absorbing layer 132 is removed. In order to facilitate this, the light-absorbing layer 132 preferably only weakly bonds to the colour-forming layer 121 during manufacture for example by means of a layer of release adhesive.

FIG. 14 shows a label substrate 11 which comprises an image-receiving material 40, an adhesive layer 41, and a backing material 42. The backing material 42 is removable so as to reveal the adhesive layer 41 such that the label comprising a portion of the label substrate 11 may be adhered to a surface to be labelled. The image receiving material may have any of the structures described previously. The label substrate may comprise a continuous length of tape and may be provided with discreet labels, so-called die cut labels.

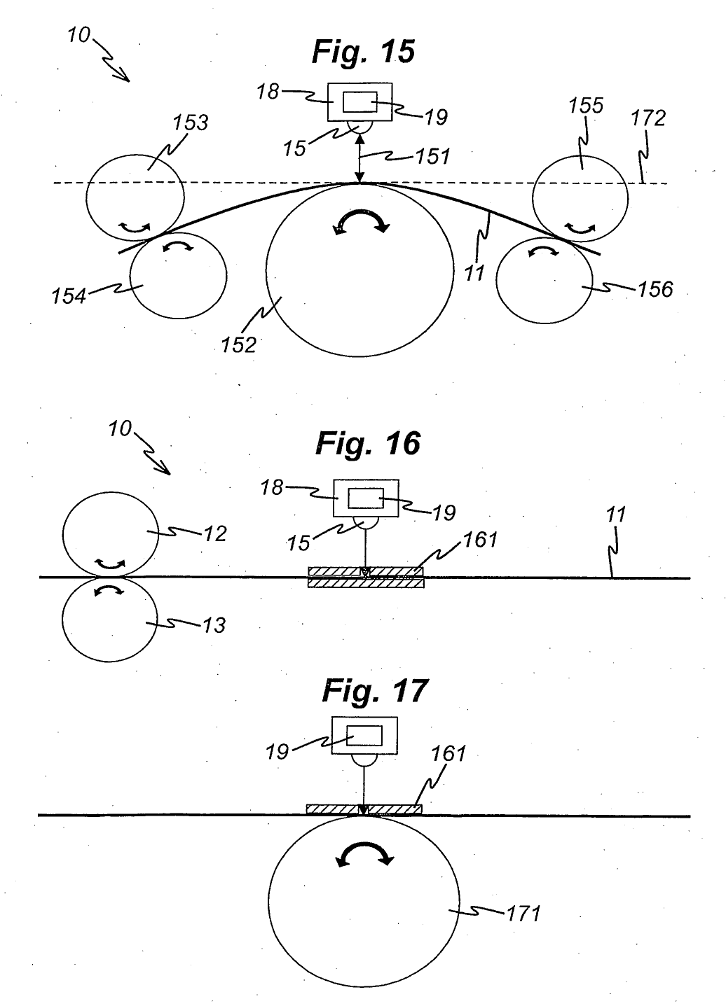

A printing apparatus 10 suitable for generating an image in the image-receiving material 40 of the label substrate 11 is shown in FIG. 15. The label substrate 11 may be supplied from a reel, said optionally reel housed in a tape cassette. The apparatus comprises at least one roller which is driven so as to drive the label substrate past a laser source 19. The apparatus shown in FIG. 15 comprises five rollers 152, 153, 154, 155 and 156, at least one of them is driven. A lens 15 is provided to focus light from the laser source 19 onto the label substrate 11. The lens 15 may be movable within a laser housing 18 in order to allow laser light to be focussed at different depths within the label substrate 11. The laser source 19 and lens 15 are mounted in a laser housing 18. To control the distance 151 between the lens and the label substrate, the tape is stretched over roller 152 and a path for the tape is created so that the tape is always positioned between the inflectional tangent on roller 152 at the point where the laser interacts with the roller and the contour of roller 152. The laser housing 18 may be movable across the width of the label substrate 11, in a direction into and out of the plane of the page containing FIG. 15. An apparatus suitable for moving the laser housing 18 across the width of the laser substrate 11 may be similar to the transverse laser tracking system of an optical disc drive.

An alternative printing apparatus 10 suitable for generating an image in the image-receiving material 40 of the label substrate 11 is shown in FIG. 16. The label substrate 11 may be supplied from a reel, said reel optionally housed in a tape cassette. The apparatus comprises at least one roller which may be driven so as to drive the label substrate past a laser source 19. The apparatus shown in FIG. 16 comprises two rollers 12 and 13, one or both is driven. A lens 15 is provided to focus light from the laser source 19 onto the label substrate 11. The lens 15 may be movable within a laser housing 18 in order to allow laser light to be focussed at different depths within the label substrate 11. The laser source 19 and lens 15 are mounted in a laser housing 18. To control the distance 151 between the lens and the label substrate, a support 161 is positioned between the laser and the tape. The support has an aperture through which the laser interacts with the image receiving medium. The support has on the side that is in contact with the tape a low coefficient of friction. The support can also be used to dissipate heat. The laser housing 18 may be movable across the width of the label substrate 11, in a direction into and out of the plane of page of FIG. 15. An apparatus suitable for moving the laser housing 18 across the width of the laser substrate 11 may be similar to the transverse laser tracking system of an optical disc drive.

Alternatively as shown in FIG. 17, the support 161 is pressed against a roller 171. The roller 171 is driven and feeds the label substrate through the printing area.

In another alternative the label substrate can be hard, not flexible media.

The label printing apparatus shown in FIG. 15, 16, 17 may be a hand held device or a desktop device.

In embodiments of the present invention, the movement of the laser can be controlled in any appropriate way to allow the laser beam to interact with the image receiving medium. For example:

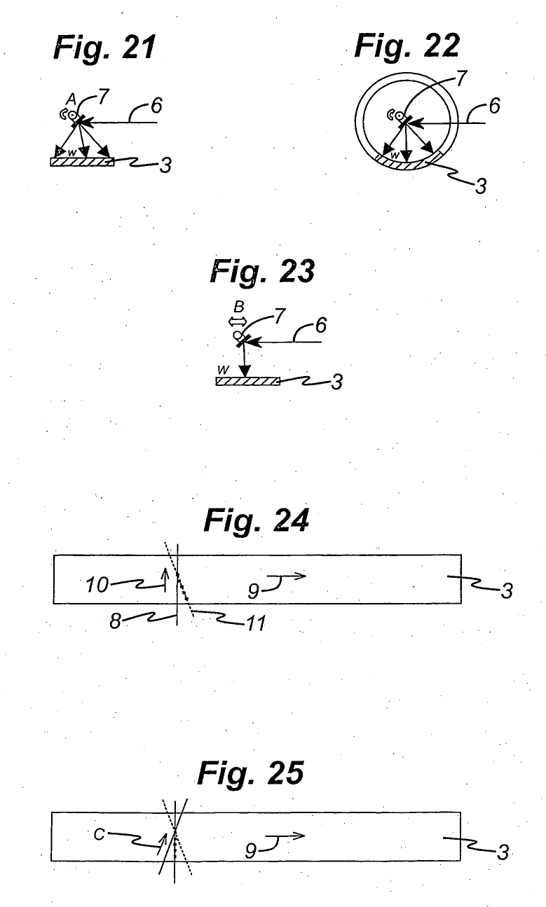

1) As shown in FIG. 21, the laser 6 is beamed onto a rotating mirror surface 7. The mirror surface which is planar is rotated about point A so that the laser beam moves over the width direction w of the image receiving tape. The image receiving tape is moved in along in the lengthwise direction.
2) As shown in FIG. 22, the distance between the laser source and the image receiving tape is kept constant. Again a rotating mirror as discussed in relation to FIG. 21 is provided but in this case the image receiving medium is curved concavely in its width direction. The curvature of the image receiving medium defines an arc of circle, the centre of which is defined by the point at which the laser beam strikes the mirror. The medium is fed in the length direction.
3) As shown in FIG. 23, the mirror is moved over the width of the medium in the direction of arrow B. There is no rotational movement of the mirror. The medium is fed in the length direction.
4) The laser directly impinges on the medium without the use of a mirror. The laser can be arranged to be move across the medium by pivoting the laser source, moving the laser source in a direction parallel to the width of, the medium or by any other suitable movement. The medium is fed in the length direction.

It should be appreciated that in some embodiments of the invention, the medium can be stationary during printing.

In one modification to embodiments of the invention, the laser beam is replaced by a array of diodes. Preferably the array would be of the same or similar size as the width of the image receiving medium or the largest size of image receiving medium usable. This avoids the need to scan.

Error correction will now be described in relation to FIG. 24. Printing an image on an image receiving medium is a serial system. This means that when a line is created over the width of the image receiving medium by moving the laser beam over the width of the image receiving medium (line of the movement of the laser beam 8), the continuous fed medium is also moving in the length direction and the result is not a vertical line but the line will be a little angled as can be seen in FIG. 24.

For example, the printer is feeding the image receiving medium with a speed of 10 mm/s and prints a print-line at 14.1 ms. The print-line has 128 dots and the printer prints with 180 dpi. In this example each dot 11 is written in 110.15 μs. A movement of the laser beam 10 perpendicular to the feeding direction 9 of the tape will result in a line under an angle of 0.45 degrees.

There are different options to remove the distortion.

The laser beam can be moved over the width of the image receiving medium, not exactly perpendicular to the feed direction but a little rotated to this so that when a line is created during a movement of the laser beam over the width of the image receiving medium, this line is perpendicular to the length direction of the image receiving medium. Arrow C illustrates schematically the path taken by the laser beam. In this way movement of the image receiving medium may be compensated for. The biggest advantage of this option is that it is not necessary to print as fast as possible to minimize the distortion.

Another option is to print faster; this is to move the laser beam faster over the width of the tape. Printing faster will minimize the distortion. The second option has the advantage that print speed variations do not have a big influence on the straightness of the printed line.

In some embodiments of the invention, the reflection of the light is dependent on the color of the label material, the intensity of the laser may be dependent on the reflection of the tape. For example, a white tape may have a high reflection and the laser intensity may be increased. A dark tape may have a low reflection and the laser intensity may be decreased. The material of the label may itself also have an impact on the reflection. Accordingly the determination of the laser intensity may additionally or alternatively take into account the material of the label. In some embodiments of the invention the reflectivity of the material is additionally or alternatively taken into account.

In one embodiment of the invention, information on the material is provided by the user via an input interface such as a keyboard or the like or may be provided by identification means associated with the image receiving material. Alternatively or additionally the degree of reflection of the label material may be measured for example by a light source arranged to direct light onto the image receiving tape and a detector arranged to detect the amount of reflected light. Using the provided or detected information, the required laser intensity can be set.

In some embodiments of the invention, some label material need to be heated on both sides of the tape. This could for example be necessary for the direct thermal color material discussed previously. This can be achieved by using two lasers, one on each side of the image receiving medium, two lasers which may be in any suitable position with mirrors being used to direct the laser beams to the required sides or alternatively by using one laser and a mirror path that divides the laser beam in two beams and two rotation points that allow control if one or both side of the image receiving material is heated.

In one modification to the above described embodiments, a plurality of laser beams are provided. The laser beams can be arranged to have different intensities and/or focuses and/or wavelengths to activate different layers and/or colours. In one example, three laser beams could be provided each with different wavelengths to thereby activate different colours in the material.

In an alternative embodiment of the present invention, the image-receiving material is applied to the label side of an optical disc. The optical disc may comprise a CD or a DVD which may be pre-recorded, recordable or re-writable. The image-receiving layer may be an annular adhesive label that is applied to the optical disc by a user. Alternatively, a label layer of an optical disc may comprise image-receiving material applied to the disc during manufacture. So called business card and promotional CDs are known where the CD is not round but instead has two parallel straight sides. Embodiments of the invention can be used with these or any other shape of CD, DVD or the like.

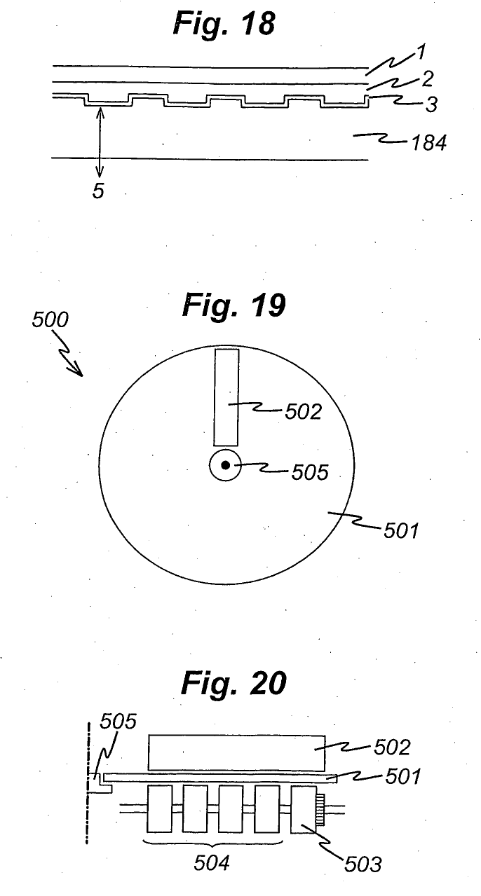

FIG. 18 shows the structure of a conventional pre-recorded optical disc comprising a label 1, an acrylic layer 2, an aluminium layer 3 and a polycarbonate layer 4. The polycarbonate layer 4 is the main supporting structure of the optical disc. The aluminium layer 3 cooperates with a read laser 5 incident upon the aluminium layer 3 from the polycarbonate layer 4 side of the optical disc in order to transfer information to a device. Recordable and re-writable optical discs have a substantially similar structure except for an additional layer situated between an aluminium layer 3 and the polycarbonate layer 4 which is responsive to a more powerful laser than a conventional optical disc read laser.

In embodiments of the present invention, the label layer 1 of the optical disc shown in FIG. 18 comprises an image-receiving material of the present invention, such as described earlier. Such an optical disc may have an image imposed upon the label surface by the application of laser energy to the surface.

FIGS. 19 and 20 show one embodiment of the present invention, in which an apparatus 500 is provided for performing direct thermal printing on a label surface of an optical disc 501. A label layer of an optical disc 501 preferably comprises one of the image receiving materials suitable for direct thermal printing described above. The apparatus 500 comprises a thermal print head 502, preferably capable of printing an image as wide as the label layer is wide, measured along a radius of the optical disc 501. In a printing position, the print head 502 abuts against and is biased towards the label surface of the optical disc 501. The opposing surface of the optical disc 501 may comprise a data surface which is supported by a plurality of rollers 503, 504. One of said plurality of rollers is a driven roller 503, adapted to rotate the optical disc 501 during a printing process in which a plurality of heating elements in print head 502 are activated and deactivated under the control of a control circuit. During, said printing process, thermally active materials in the image receiving material of the label layer of optical disc 501 react so as to create an image on the label layer. The optical disc 501 is preferably rotatably mounted on a rotating hub 505. Rotating hub 505 preferably comprises releasable clips for gripping said optical disc 501 around an edge of a central hole of optical disc 501.

In another embodiment of the present invention, the image-receiving label layer of an optical disc is adapted to cooperate with for example the write laser of a re-writable optical drive in order to impose an image on the label side of the optical disc when the optical disc is inserted into the re-writable optical disc drive with the label side down such that it faces the laser of the drive.

In another embodiment, a separate laser is provided on the side of the disc opposite to a data face. The data face of an optical disc is the face to which information is read/written.

Detecting data tracks on a data face of an optical disc is known. Known Recordable and Rewritable optical disc drives can also detect blank recordable and rewritable optical discs. In preferred embodiments of the present invention software used to control a label printing process using an optical disc drive first performs this known detection in order to prevent the process being performed on the data face of an optical disc.

In alternative embodiments of the present invention, a central portion of a label surface is readable by a laser of an optical disc drive. The central portion is used to store a code, for example a bar code. The bar code is read by the laser of the optical disc drive and compared to a plurality of stored bar codes. Responsive to a match between the read bar code and the stored bar code, the software retrieves further information indicating the properties of the image-receiving label layer of the disc. This information is used to control the printing process, in particular the duration and intensity of the laser applied to the label layer. If no bar code is detected or an unrecognised bar code is detected, the software may prevent printing on the disc. Alternatively the software may ask a user, through a graphical user interface, to confirm printing should be carried out on the unrecognised disc surface.

Preferably, the power and duration of the write laser of a re-writable optical disc drive is dynamically varied so as to produce different temperatures at the surface of the label layer for different durations in order to produce different colours in a label comprising multicolour image-receiving material.

In an alternative embodiment, an optical drive is provided with a dedicated print laser. The print laser is of variable power and faces the side of the disc opposite to that faced by the conventional read/write assembly of an optical disc drive. Such an apparatus may record data on one side of a disc and simultaneously print an image on the other.

The write laser of a re-writable CD drive typically operates at approximately 790 nanometres in wavelength. Accordingly, the image-receiving material in the label layer of an optical disc intended for cooperation with the write laser of a CD re-writable drive is adapted to print with a laser at 790 nanometres in wavelength.

A conventional optical disc drive is capable of focussing a read or write laser at a certain depth of an optical disc in order to achieve a maximum resolution when reading from or writing to the disc.

In an alternative embodiment of the present invention, the write laser of the optical disc drive is arranged to focus at one of colour-forming layers so as to develop each of the three colours independently.

In an alternative embodiment of the present invention, three colour-forming layers are spatially separated in space so as to provide colour separation in the image-receiving material. A first, a second and a third colour-forming layer are each moderately absorbing to light of a single frequency. Laser light is applied to the image-receiving material from a source capable of focussing at each of the three different depths coinciding with each of the three colour-forming layers.

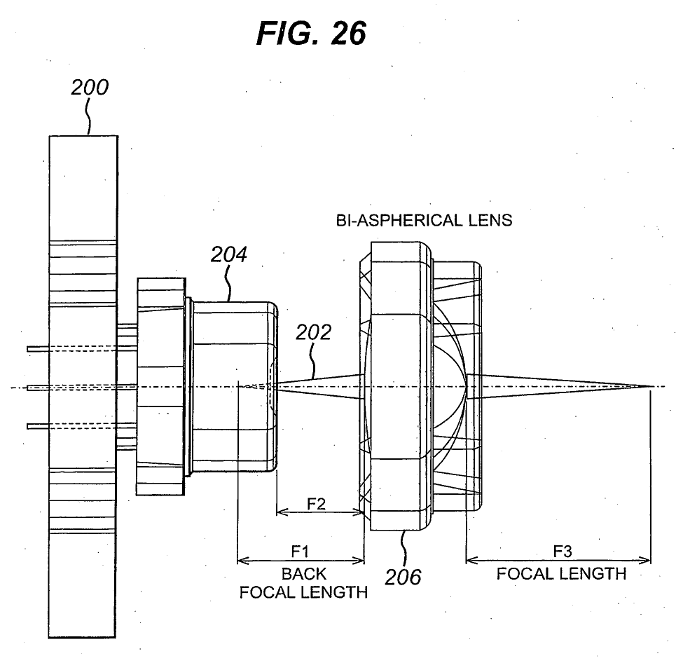

FIG. 26 shows an optical set up, which can be used in embodiments of the present invention. Because a laser beam will diverge from its source, an optical arrangement is provided to focus the emitted light beam. The arrangement comprises a circuit board or the like 200 on which a laser diode 204 is mounted. The circuit board or the like 200 may support other components such as the laser diode driver circuitry. A collimator lens 206 is provided in line with the laser diode beam axis 202. The lens may for example be a full plastic bi-aspherical lens such as the CAY046N670 provided by Philips. Of course other suitable lenses may alternatively be used. The distance between the laser point source and the back of the lens is the back focal length F1. The distance between the surface of the laser diode and the back of the lens is marked F2. The distance between the opposite surface of the lens 206 and the focal point is marked F3. The focal point will be on or in the material on which the image is to be printed.

The lens can be mounted in any suitable manner. For example the lens can be mounted by a spring loaded or biasing mechanism or using glue or any other suitable adhesive.

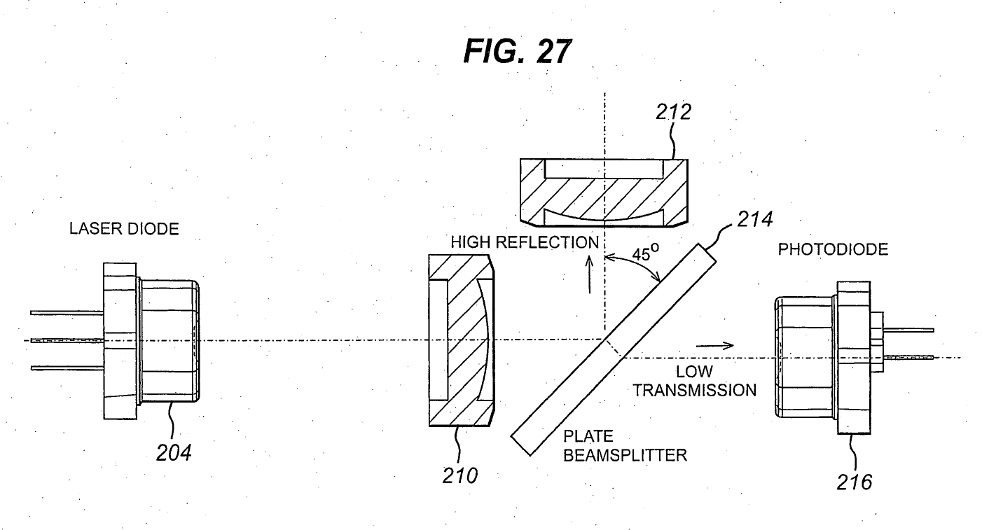

Reference is now made to FIG. 27 which shows a second optical arrangement aspects of which can, but not necessarily, be used in conjunction with the arrangement of FIG. 26. In the arrangement of FIG. 27 a photodiode 216 is provided in order to provide a measure of the intensity of the laser beam. Using this measure, the intensity of the laser beam may be controlled to be with a desired range or to have a desired value using a feedback loop.

The laser diode 204 provides a laser beam which is incident on a first lens 210. The first lens 210 focuses the laser beam onto a beam splitter 214 which is positioned such that most of the laser light is reflected by 45 degrees onto a second lens 212 and a small amount passes through the beam splitter 214 onto the photodiode 216. The first and second lenses are aspherical plano-convex lenses. The beam splitter is arranged at 45 degrees to both the first and second lenses. In order to be able to determine the intensity of the laser beam from the intensity of the laser beam incident on the photodiode, it is necessary to know the percentages of reflection to transmission of the beam splitter coating for the used wavelength.

In preferred embodiments of the invention, the laser diode and lens or lenses are arranged to have a fixed back focal length between the laser diode and the lens. Both of the diode and the lens may be built into the same case work or housing. In case that the distance between the lasers diode and the collimating lens needs to be adjustable, the lens can be mounted in a lead screw adjustable mount or the like.

If the image size, ie the area of the focus point on the recording medium has to be variable, a frame containing the laser diode and the aligned collimating lens can be moved by:

Manual adjustment using a lead screw

Motorised adjustment

Electromagnetic field movement in a permanent magnetic field.

In embodiments where the collimating lens is glued in place, a UV curing block adhesive is preferably used.

The following describes on implementation of an embodiment of the invention based on a laser diode setup. In order to provide an imaging result, first the high energy carrying beam emitted by a laser diode and focused by the mating lens setup has to be converted into heat. Therefore a specific dye has to be used which absorbs the specific emitted laser beam wavelength. The absorbed amount of energy at the imaged spot (focused beam) converts into heat by a joule effect. Laser diode frequency absorption dyes or powders are specially designed to absorb a specific wavelength. These dyes may insoluble in water but soluble to some degree in organic solvents and are compatible with plastics and resins. As such they can be formulated into solid plastic resins suitable for injection moulding and/or extrusion applications. Some dyes have sufficient solubility in common organic solvents to be used in coatings and inks.

The laser absorption dyes in the red visible range (around 650 nm) are based on phthalocyanine or triarylmethine. For other visible wavelengths, absorbing dye types based on perinone, rhodamine, cyanine and anthriquinone can be used.

### Laser Absorption Dye to be Used in Conjunction with Red Visible Laser Wavelength

Phthalocyanine or triarylmethine dyes are soluble in common organic solvents and have excellent thermal stability. Phthalocyanine dye stands up to long-term epoxy-curing. The higher the absorption of the phthalocyanine dye, the better will be the light-to-heat conversion.

### Examples of Phthalocyanine Dye Formulations:

1) sicpa ink: code nr. 748080x

2) epolin dye: epolight 6084™ (maximum absorption wavelength 684 nm)

3) epolin dye: epolight 6158™ (maximum absorption wavelength 675 nm).

### Example of Triarylmehtine Dye Formulation:

1) epolin dye: epolight 5410™ (maximum absorption wavelength 658.9 nm)

A phthalocyanine is a macro cyclic compound having an alternating nitrogen atom-carbon atom ring structure. The molecule is able to coordinate hydrogen and metal cations in its center by coordinate bonds with the four isoindole nitrogen atoms. The central atoms can carry additional ligands. Most of the elements have been found to be able to coordinate to the phthalocyanine macrocycle. Therefore, a variety of phthalocyanine complexes exist.

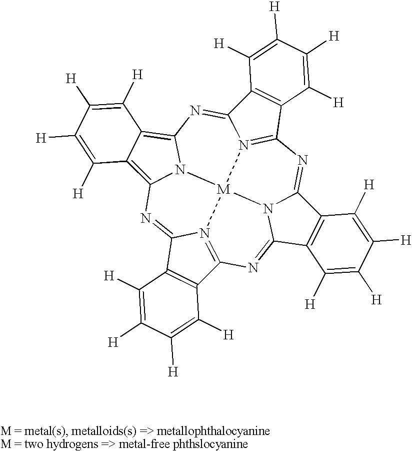

### Molecular Structure of Metallophthalocyanine, Metal-Free Phthalocyanine

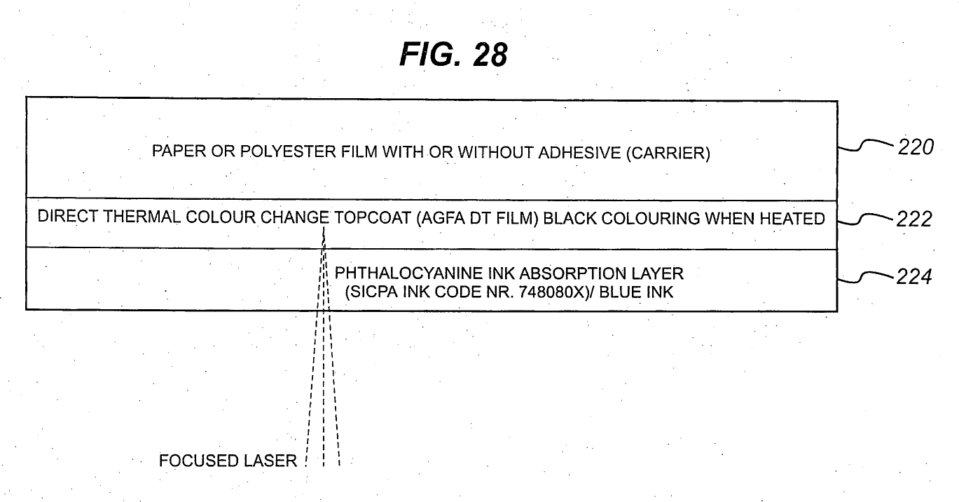

An example of a material used in embodiments of the invention is shown in FIG. 28. This material comprises out of a polyester or paper base film 220 with a direct thermal topcoat or layer 222 what contains a heat sensitive colour change chemistry. The top 224 of the base film is coated a phthalocyanine ink (dye) what develops heat when activated with a red laser beam (±658 nm). If another laser wavelength is used, another laser absorption dye has to be used. The heat development depends on the time the laser is enabled, the intensity of the laser diode, the concentration of wavelength absorbing pigment in the heat development dye and the thickness of the wavelength absorbing layer.

The wavelength absorbing dye can also be processed into the direct thermal colour changing topcoat. This means that only one topcoat has to be added on the base layer (paper or polyester).

The wavelength absorbing dye can also be placed under the colour change layer. If necessary, a protective lacquer overcoat can applied above the top layer to provide protection against scratches and solvents. This layer must have a high level of transmittance for the used wavelength.

Embodiments were coated with four different thicknesses of phthalocyanine based sicpa 748080x ink (42 μm-40 μm-38 μm-36 μm). The base material was afga clear polyester direct thermal tape. The laser wavelength used: 658 nm (red visible). The laser beam was focused onto the target (film). Good results were obtained with for example 38 nm. The thicker the ink layer, the quicker that the heat is absorbed. In contrast, the lower the thickness, the finer or smaller the imaged clots are. In embodiments, the concentration of wavelength absorber in the ink may be the same or different.

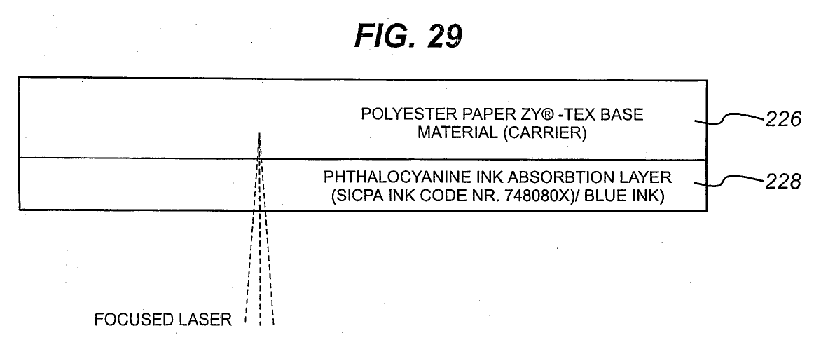

Another embodiment of the present invention used a direct thermal relief imaging material as shown in FIG. 29. This material comprises of a base material 226 what expands when heated. A heated spot on the base material will generate a 3d pop-up reaction on the surface. This type of material has different applications one of which is to generate a Braille image. On top of this base material is coated a phthalocyanine ink (dye) layer 228 what develops heat when activated with a red laser beam (±658 nm). In case another laser wavelength is used, another laser absorption dye has to be used. The heat development depends on the time the laser is enabled, the intensity of the laser diode, the concentration of wavelength absorbing pigment in the heat development dye and the thickness of the wavelength absorbing layer.

The wavelength absorbing dye can also be processed into the direct thermal relief forming base material what makes a topcoat superfluous. Because of the relief forming, Braille relief dots and other reliefs requiring characters, charts and/or images can be directly written onto the base material. This means this material can be used in combination with a direct Braille laser printer.

The thicknesses of phthalocyanine based sicpa 748080x ink can be for example 42 μm-40 μm-38 μm-36 μm. The base material can be for example Zy®-tex2 swell paper supplied by Zychem ltd. The laser wavelength used: 658 nm (red visible) and the laser beam was focused onto the target (film).

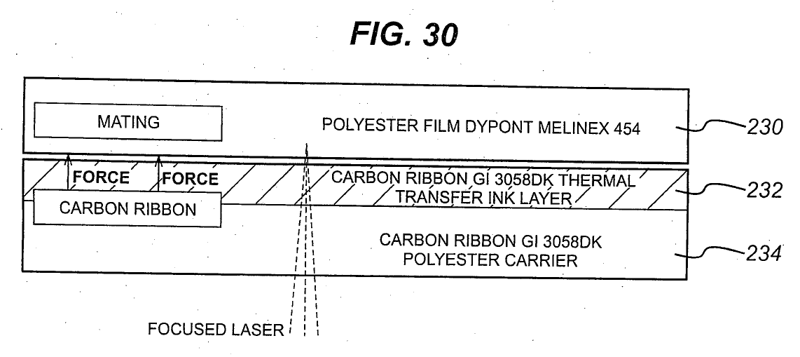

A laser thermal transfer imaging, marking and/or engraving material will now be described with reference to FIG. 30. The basic material comprises of a laser sensitive thermal transfer ink ribbon. A heated spot on the backside of the transparent carrier film 234 will develop a softening of the thermal transfer ink on the exterior top side of carrier film 234. Beneath the thermal transfer ink layer 232 is a coating of a phthalocyanine ink (dye) on the transparent carrier film 234 (polyester film, or other type of film) which develops heat when activated with a red laser beam (±658 nm). In case another laser wavelength is used, another laser absorption dye has to be used. The heat development depends on the time the laser is enabled, the intensity of the laser diode, the concentration of wavelength absorbing pigment in the heat development dye and the thickness of the wavelength absorbing layer.

The wavelength absorbing dye can also be included in the thermal transfer ink so that only the adapted thermal transfer ink has to be coated on top of the carrier film. Also without a laser absorption dye, the thermal ink transfers to the mating surface. The absorption dye only increases the ink softening speed resulting in a faster ink transfer. The higher the intensity at the focus point, the deeper thermal transfer inks burns into the mating surface resulting in a permanent marking and/or engraving. This results in a high scratch and solvent resistance of the image (text, curve, drawing, etc . . . ). The to be imaged object can be a film, cables, pipes, pens, etc. . . . To have an optimal transfer of the thermal ink, the film has to make optimal contact with the to be imaged mating target.

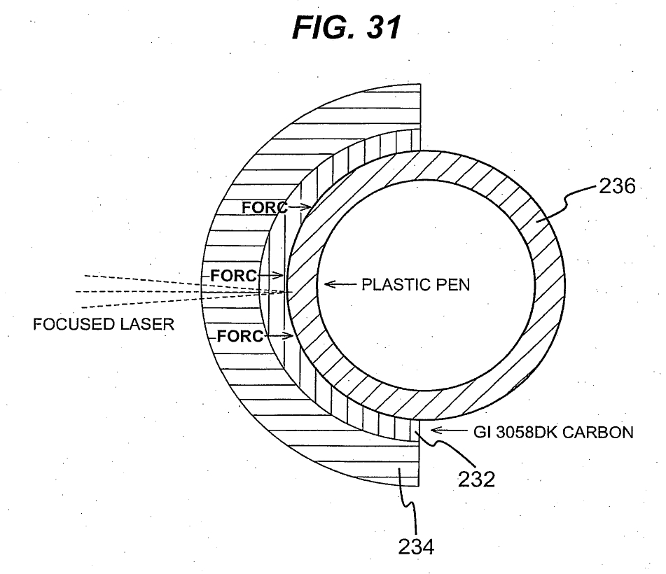

Reference is now made to FIG. 31 which shows a plastic pen 236 on which an image is printed using a material comprising layers 234 and 232 of FIG. 30. Layer 232 is in contact with the surface of the pen 236. Laser light is incident on layer 234 and then layer 232. The laser beam is focused on the surface of the pen 236. This technique can be used to print on any shape or suitable type of surface.

Laser thermal spray imaging material can be used in embodiments of the present invention. The basic material comprises an aerosol spray containing a laser sensitive thermal transfer pigment (any colour) and a wavelength absorber to transfer the wavelength energy into heat. First the pigment holding aerosol spray will be sprayed onto the to be imaged surface. This spray will dry instantly or in a short period of time in preferred embodiments of the invention. A focused laser spot (where the laser wavelength corresponds with the absorption peak of the wavelength absorber) on the sprayed surface will generate the required heat to cause a colour change in the sprayed topcoat on the target surface. Due to the heat development, the colour changed dot in the sprayed topcoat will attach to or join with the target surface beneath. After removing the remaining spray (optional cleaning action) of the target surface, only the image will be left on the target surface.

The following describes colour imaging method based on using a laser diode setup embodying the present invention.

A full range of colours can be generated by mixing the three head colours red, green and blue. Alternatively the colours yellow, magenta and cyan can also be used as head colours.

The intensity of each composed colour depends on the luminance and saturation of the three head colours.

Various different material combinations to provide full colour imaging based on laser technology will be mentioned.
1. Materials based on the usage of three base colour thermal pigments (red/green/blue or cyan/magenta/yellow) and a black coloured carrier or ground surface will be mentioned.
2. Material based on the usage of three base colour thermal pigments (red/green/blue or cyan/magenta/yellow) and a black colour thermal pigment will be mentioned.

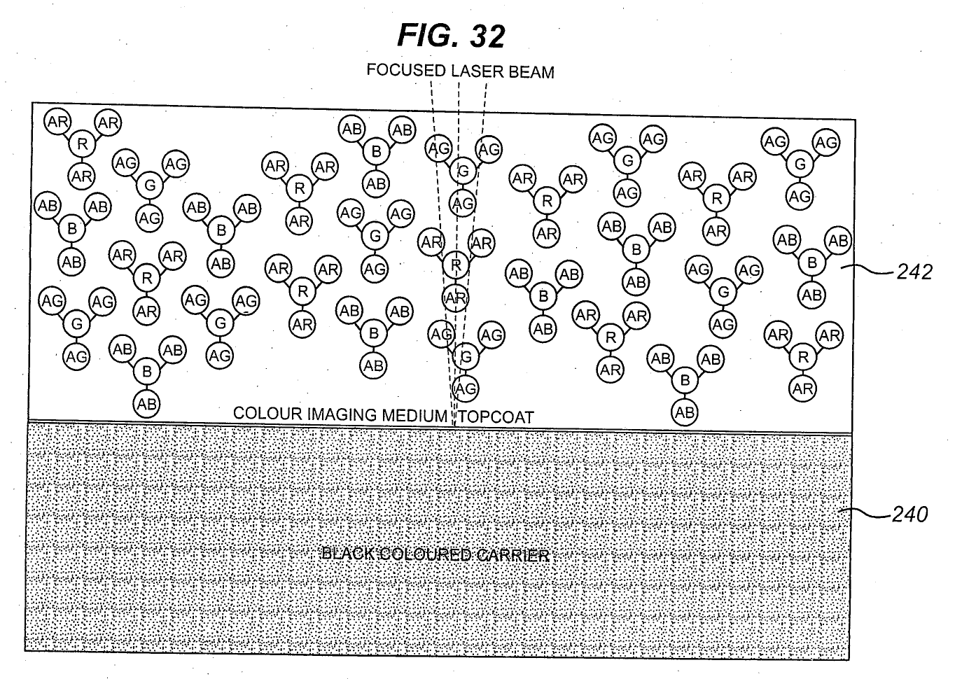

Reference is made to FIG. 32. The composition of the material is based on a black carrier (polyester, paper, etc . . . ) 240. An adhesive and/or release liner may optionally be provided. On top of the black coloured carrier is placed a laser wavelength sensitive topcoat or layer 242 (scratch and solvent resistant if possible) containing the three base colours (red, green, blue and/or cyan, magenta, yellow). Each base colour thermal pigment is linked to its individual laser wavelength absorber to provide a laser light-to-heat conversion effect. All three base colours with linked wavelength absorbers are mixed into a solid medium which forms the topcoat layer. Because all colours except black can be formed with the three base colours, the carrier or target surface on which the topcoat is layer is provided is black or nearly black. This black carrier or target surface generates a solid black background image when topcoat has not been imaged by an emitted focused laser beam.

Each wavelength absorber linked to a base colour reacts on a different laser peak wavelength. So, a specific colour change will only happen when the correct laser beam wavelength for that colour has been absorbed by the medium. To provide full colour three different wavelengths have to be provided.

FIG. 32 shows a material with full colouring red, green, blue thermal imaging pigments in laser sensitive topcoat medium on a solid black carrier or target surface
Ar=wavelength absorber linked to red colouring thermal pigment
Ag=wavelength absorber linked to green colouring thermal pigment
Ab=wavelength absorber linked to blue colouring thermal pigment
R=red colouring thermal pigment
G=green colouring thermal pigment
B=blue colouring thermal pigment
_=pigment to wavelength absorber link

As can be seen each pigment molecule is surrounded by wavelength pigment molecules.

In an alternative red, green and blue can be replaced by cyan, magenta, and yellow thermal imaging pigments.

In an alternative material, the topcoat composition with the three pigment colours are integrated into the black carrier or target medium. The colour imaging pigment composition can be formulated into solid plastic resins suitable for injection molding and/or extrusion applications (plastic films).

In one alternative, a black thermal colouring pigment is incorporated in the topcoat in addition to the three colour pigments. Four different wavelength are now required to activate the four different ink colours. The carrier may be white or transparent.

In one modification the pigments (three or four) are integrated into carrier or medium. The carrier can be supplied with or without adhesive and/or release liner.

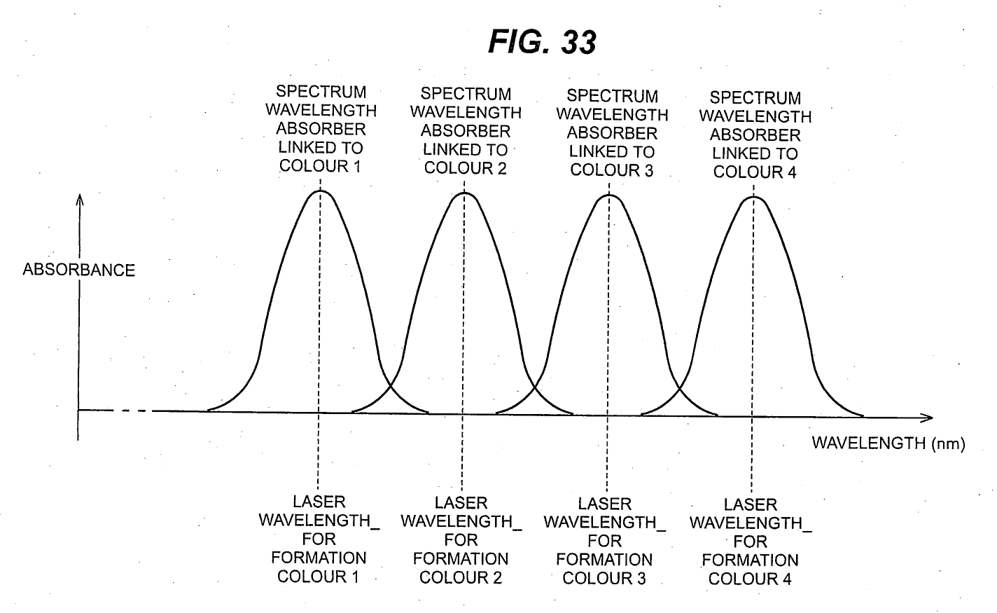

Reference is made to FIG. 33 which shows a graph of absorbance versus wavelength for full colour laser thermal imaging. Three or four wavelength absorbers, to absorb the light energy emitted by three or four different wavelength emitting laser diodes or laser emitters and to release the captured energy into heat to warm up the thermal colour pigment linked to each absorber are necessary to form the full colour spectrum. Each thermal colour pigment has to be linked to its absorber by a different type of chemical connector to avoid mix up during processing of these absorber/pigment-combinations into the topcoat, film, plastic, etc

The medium, in which the absorber/pigment-combinations are processed, has to avoid that the extreme heat generated in one wavelength absorber affects the thermal colouring pigments in the neighbouring absorber/pigment-combinations (temperature is lower than pigments colour change temperature offset point). Various of the materials described above may be used.

Colour mixing can be achieved by mixing the pigment colours at the same focus point by emitting the different laser beam wavelengths at the same time. Alternatively each individual colour can be transferred in a pattern next to each other to provide a mixed colour appearance.

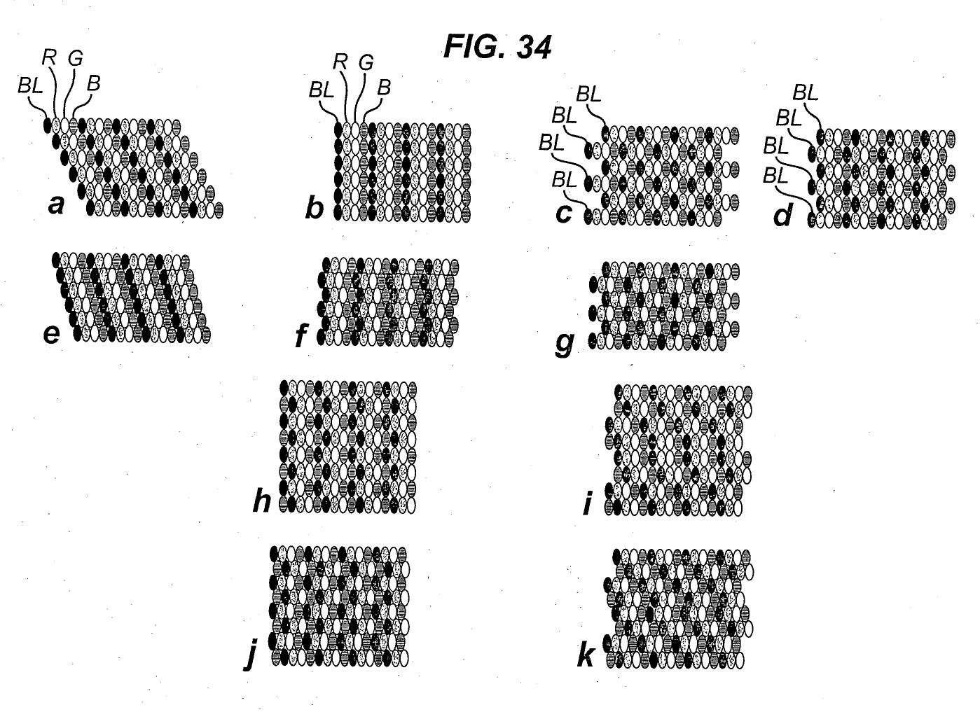

Various types of four colour based appearance dot patterns will now be described with reference to FIG. 34. In FIG. 34a, diagonal raster lines of individual colours are used. Accordingly, there is a first diagonal line of black BL, followed by an adjacent diagonal line of red R, followed by an adjacent line of green G, followed by an adjacent line of blue B. This pattern is repeated.

The pattern shown in FIG. 34b is similar to that shown in FIG. 34a but the lines are straight.

In FIG. 34c, a different pattern is used. This pattern will be explained with respect to black BL. In every other line, the black dots are in alignment. Thus, the black dots are aligned in the odd rows and the black dots are aligned in the even rows. However, the black dots in the odd and even rows are offset by two dots. FIG. 34d shows a similar arrangement where the offset is one dot. In the arrangement shown in FIGS. 34a to 34d, the dots are aligned. Thus, a dot in one row has a dot directly below it in the next row and so on.

In the arrangement shown in FIGS. 34e to g, an interlocking arrangement is shown. This means that a dot on one line is accommodated in a position the centre of which is defined by the gap between two dots in the next line and so on. In FIG. 34e, a diagonal arrangement is used, similar to that shown in FIG. 34a. FIG. 34f corresponds to FIG. 34b but with the dots in adjacent rows offset by half a dot position. Likewise, FIG. 34j corresponds to 34c with the offset between the odd and even rows being one and a half pixels.

FIG. 34h shows an arrangement where the pixels in odd and even rows are aligned. However, the odd rows will have two colours and the even rows will have two colours. For example, red and black may be provided on the odd rows while green and blue will be provided on the even rows. The pixels are provided in alternative colours. The black pixels in the different odd rows will be aligned as will be the red pixels. Likewise, the green pixels from different even rows will also be aligned as will be the blue pixels.

FIG. 34i shows a similar arrangement to that shown in FIG. 34h. However, for the odd lines, alternate line will have alternative alignments. For example, a black dot in the first line will be aligned with a red dot in the third line and a red dot in a first line will be aligned with a black dot in the third line and so on. This also applies to the green and blue dots in the second and fourth lines and so on.

FIG. 34j shows an arrangement similar to that shown in FIG. 34h but with the even lines offset with respect to the odd lines by half a dot.

FIG. 34k is similar to that shown in FIG. 34i but with the even rows additionally offset with respect to the odd rows by half a pixel.

It should be appreciated that embodiments which only use three colours may be modified to take this into account.

In embodiments having a multi-laser source, each individual wavelength (monochromatic light) has to be emitted by a different laser emitter. In case three wavelengths are required, three laser diodes each emitting a different wavelength has to be used. Alternatively an array containing three laser emitters each emitting a different wavelength can be used. In case four wavelengths are required, four diodes or emitters will be required.

The optical output (energy) of each wavelength emitter or laser diode is controlled individually to provide a mixture of the complete colour spectrum when using all wavelength emitters.

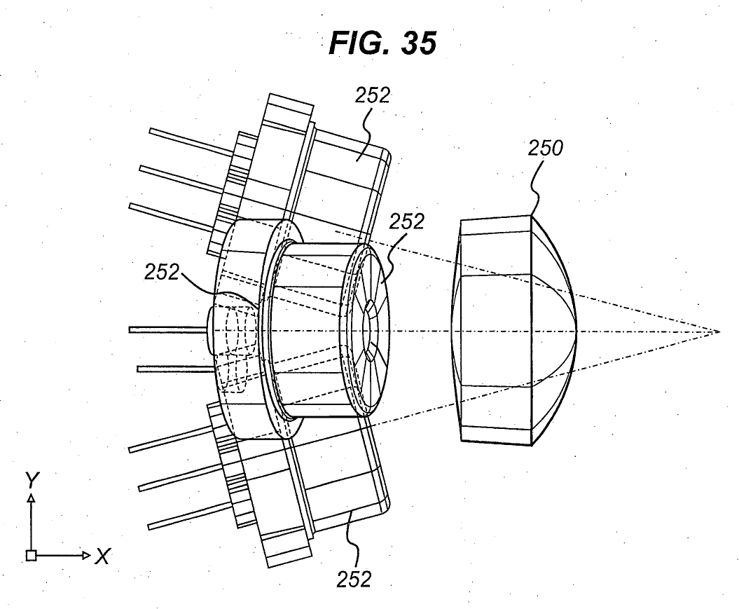

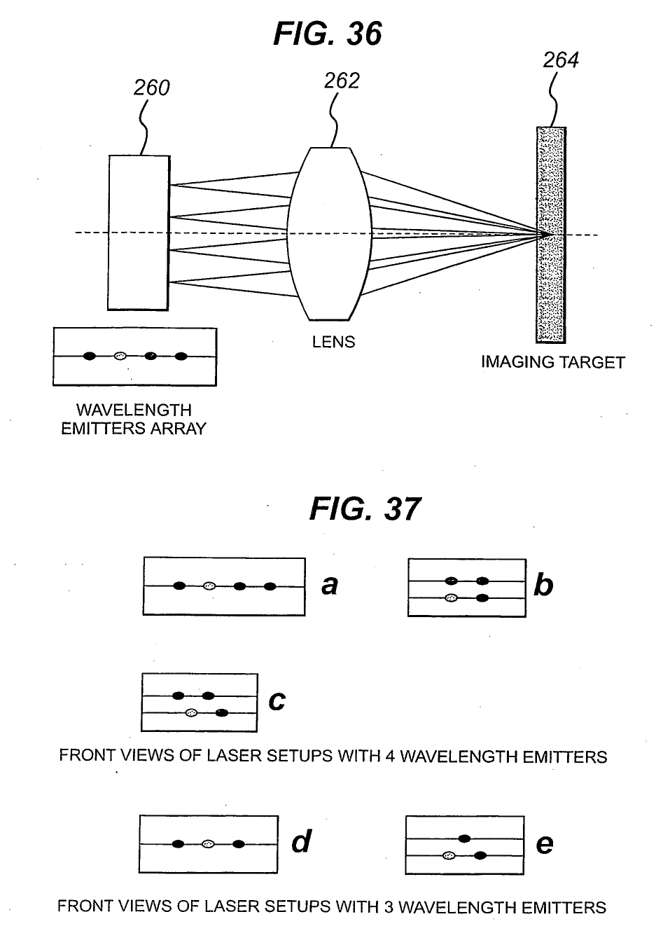

Reference is now made to FIG. 35 which shows an embodiment of the present invention in which a single lens 250 is used to focus the light from four diodes (252) onto a single focal point. In alternative embodiment of the present invention, a lens may be provided for each laser light source. The lenses can take any suitable form but in preferred embodiments of the present invention are bi-aspheric. Of course, if there are only three laser light sources, then the lens arrangement may differ slightly. FIG. 35 shows the case where one lens is used. Reference is now made to FIG. 36 which shows a laser diode array 260 with a plurality of individual emitters. The number of emitters will either be three or four depending on how many different wavelengths are required. The output of the array is incident on a lens 262 which focuses the light of different colours onto an imaging target 264. In the arrangement shown in FIG. 36, the four emitters are arranged in line.

However, as shown in FIG. 37, the emitters can be placed in a number of different set ups. In FIG. 37a, the four emitters are aligned. In FIG. 37b, the emitters are divided up into two rows with the emitters in each row being aligned. In FIG. 37c, the emitters are again arranged in two rows with the emitters in one row offset with respect to the emitters in the other row. FIG. 37d shows the set up where there are just three wavelength emitters. The emitters are in row. In FIG. 37e, the three emitters are arranged with two in one row and one in the other with the single emitter being arranged in a position halfway between two emitters in the same row.

It should be appreciated that embodiments of the present invention can be incorporated in a label printer which is either handheld or desktop. The label material or recording medium can either be in the form of discrete labels (die cut labels) or can be in the form of a continuous tape. The label material or recording medium may be incorporated in a cassette or provided on a roll. The label printer can be connected to a PC or the like. The user inputs the image via the PC and sends the image to the label printer for printing. Alternatively the label printer can be a stand alone printer with its own data entry means such as a keyboard, touch screen or the like. A display may be provided. If the label material or recording medium is in the form of a continuous material a cutter may be provided. The cutter may be manual and/or automatic.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1-38. (canceled)

39. A label for an optical disc, said label comprising a direct thermal printing material having at least one planar layer, said planar layer containing thermally activatable materials, wherein said planar layer forms an image upon application of laser light.

40. A label as claimed in claim 39, wherein said label comprises an adhesive backing layer for application to an optical disc.

41. A label as claimed in claim 39, wherein said label is provided as part of an optical disc.

42. A label as claimed in claim 39, wherein said direct thermal printing material is arranged to react to light at a frequency of laser light emitted by a laser of an optical disc drive.

43. A label as claimed in claim 39, wherein said direct thermal printing material is adapted to react to light at a wavelength of 790 nm±50 nm.

44. An optical disc drive comprising a direct thermal printing apparatus for an optical disc, said optical disc comprising a data face and a label face, said data face being parallel to said label face, wherein said label face comprises a direct thermal printing material and wherein said optical disc drive comprises:
a driven hub for rotatably mounting said optical disc;
a data apparatus arranged to at least read data from a data face of said optical disc;
at least one print laser arranged to print an image to a label face of said optical disc, wherein said print laser is mounted on a laser support, wherein said laser support is arranged to move between an inner circumference and an outer circumference on the label face.

45. A printing apparatus for printing labels, said printing apparatus comprising at least one laser for printing an image on a direct thermal printing material be applied to a disc, said direct thermal printing material comprising at least one planar layer containing thermally activated materials, said at least one laser being arranged to activate said thermally activated materials to define an image.

46. A label printing apparatus comprising at least one print laser arranged to apply laser light to a label material so as to generate an image.

47. An apparatus as claimed in claim 44, wherein means are provided to modulate the power supplied to the at least one laser as to modulate the density of image produced in said printing material

48. A label printing apparatus as claimed in claim 44, wherein said at least one laser comprises an array of laser diodes.

49. A label printing apparatus as claimed in claim 44, wherein at least one laser beam provided by said at least one laser is arranged to move with respect to said label material.

50. A label printing apparatus as claimed in claim 49, wherein said laser beam is arranged to be moved at an angle to said label material so that in use a line desired to be perpendicular on the label material is printed perpendicularly.

51. A label printing apparatus as claimed in claim 49, wherein a laser source of said laser is arranged to move.

52. A label printing apparatus as claimed in claim 49, wherein a mirror is provided, and said laser beam is arranged to reflect off said mirror onto said label material.

53. A label printing apparatus as claimed in claim 52, wherein said mirror is arranged to move.

54. A label printing apparatus as claimed in claim 53, wherein said mirror is arranged to move by at least one of pivoting about a pivot point and moving in a direction parallel to the surface of said label material.

55. A label printing apparatus as claimed in claim 44, wherein the intensity of at least one laser is controlled in dependence on at least one of the colour, the reflectivity and the material of the label material.

56. A label printing apparatus as claimed in claim 44, wherein said label material is planar during printing.

57. A label printing apparatus as claimed in claim 44, wherein said label material is curved during printing.

58. A label printing apparatus as claimed in claim 44, wherein a member is provided between at least one laser and said label material.

59. A label printing apparatus as claimed in claim 58, wherein said member has an opening through which the laser beam passes to impinge on said label material.

60. A label printing apparatus as claimed in claim 58, wherein said member is arranged to cooperate with a second member to hold the label material there between.

61. A label printing apparatus as claimed in claim 60, wherein said second member has a curved surface.

62. A label printing apparatus as claimed in claim 44, wherein at least one laser beam is arrange to impinge on a first side of the label material and at least one laser beam on an opposite side of the laser material.

63. A label printing apparatus as claimed in claim 62, wherein at least one laser is provided on the first side of the label material and at least one laser is provided on the opposite side of the label material.

64. A label printing apparatus as claimed in claim 62, wherein at least one mirror is provided whereby at least one laser beam is directed on the first side of the label material and at least one laser beam is directed on the opposite side.

65. A label printing apparatus as claimed in claim 44, comprising a plurality of lasers operating at different wavelengths, said lasers arranged to provide different colours in an image on said label material.

66. A label printing apparatus as claimed in claim 65, wherein a single lens is provided to focus the light from the plurality of lasers to a common focal point.

67. A label printing apparatus as claimed in claim 65, wherein a lens is provided for each laser, each of said lenses being arranged to focus laser light to a common focal point.

68. A label printing apparatus as claimed in claim 66, wherein the or each lens comprises a bi-aspherical lens.

69. A label printing apparatus as claimed in claim 44, wherein a beam splitter is provided whereby a first proportion of said laser light is focused on said label material and a second proportion is focused on a detector arranged to provide a measure of the intensity of said laser light.

70. A label printing apparatus as claimed in claim 69, wherein said first proportion is substantially greater than said second proportion.

71. A label printing apparatus as claimed in claim 44, wherein said measure of intensity of said laser light is used to control the intensity of said laser light.
